(19) United States
(12) Patent Application Publication
(10) Pub. No.: US 2011/0070526 A1
(43) Pub. Date: Mar. 24, 2011

(54) FUEL CELL

(75) Inventors: Wei-Kai CHANG, Taoyuan County (TW); Chi-Yang CHIU, Taoyuan County (TW); Ching-Sen YANG, Taoyuan County (TW); Chiang-Wen LAI, Taoyuan County (TW)

(73) Assignee: NAN YA PCB CORP., TAOYUAN COUNTY (TW)

(21) Appl. No.: 12/618,568

(22) Filed: Nov. 13, 2009

(30) Foreign Application Priority Data
Sep. 22, 2009 (TW) TW98131901

(51) Int. Cl. H01M 2/08; H01M 2/00

(52) U.S. Cl. 429/509; 429/516; 429/517

(57) ABSTRACT

A fuel cell includes a first mono-sided channel plate, at least one double-sided channel plate, a second mono-sided channel plate, a plurality of membrane electrode assemblies, and a plurality of rigid hydrophilic gaskets. The double-sided channel plate includes a first side channel and a second side channel. The membrane electrode assemblies are respectively disposed between the first mono-sided channel plate and the double-sided channel plate and between the double-sided channel plate and the second mono-sided channel plate. The rigid hydrophilic gaskets are respectively abutted between the first mono-sided channel plate and one of the membrane electrode assemblies, between one of the membrane electrode assemblies and the first side channel of the double-sided channel plate, between the second side channel of the double-sided channel plate and one of the membrane electrode assemblies, and between one of the membrane electrode assemblies and the second mono-sided channel plate.

### CROSS REFERENCE TO RELATED APPLICATIONS

This Application claims priority of Taiwan Patent Application No. 098131901, filed on Sep. 22, 2009, the entirety of which is incorporated by reference herein.

### BACKGROUND OF THE INVENTION

1. Field of the Invention

The invention relates to a fuel cell, and more particularly to a fuel cell that effectively prevents leakage and mixing of fuel and oxygen therein.

2. Description of the Related Art

Fuel cells employ fuel, such as methanol or hydrogen, and oxygen to generate electricity. To enable an electrochemical reaction in a fuel cell, fuel and oxygen are respectively transported into the fuel cell via proper passages. Here, the structure of the passages must prevent the fuel and oxygen from leaking and mixing with each other, such that good operational efficiency can be maintained and required operational safety can be ensured.

A conventional fuel cell often comprises a plurality of cell units. Each cell unit comprises a membrane electrode assembly (MEA) having a proton exchange membrane, an anode catalyst layer, and a cathode catalyst layer.

Proper gas passages are formed in the fuel cell for transporting the fuel and oxygen thereinto, enabling the electrochemical reaction (or a redox reaction). For example, for a fuel cell employing methanol (CH₃OH) as fuel, the methanol and oxygen are respectively transported to an anode reaction side and a cathode reaction side of each membrane electrode assembly, performing the redox reaction. Here, the redox reaction at the anode reaction side and cathode reaction side is as follows.

At the anode reaction side: CH₃OH+H₂O CO₂+6H⁺+6e⁻

At the cathode reaction side: 3/2O₂+6H⁺+6e⁻3H₂O

Accordingly, to provide an airtight effect among the gas passages of the fuel cell, a gasket is disposed between two adjacent members, preventing the fuel and oxygen from leaking and mixing with each other.

Referring to FIG. 1, a conventional fuel cell 1 comprises a first oppressive collector board 11, a second oppressive collector board 12, a first mono-sided channel plate 21, a second mono-sided channel plate 22, a plurality of double-sided channel plates 30, a plurality of membrane electrode assemblies 40, and a plurality of gaskets 50. The first mono-sided channel plate 21 and second mono-sided channel plate 22 respectively abut the first oppressive collector board 11 and second oppressive collector board 12. The gaskets 50 are respectively attached between the first mono-sided channel plate 21 and the membrane electrode assembly 40, between the membrane electrode assembly 40 and the double-sided channel plate 30, and between the membrane electrode assembly 40 and the second mono-sided channel plate 22 by soft or rigid washers with glue. The first oppressive collector board 11 is opposite the second oppressive collector board 12. The first mono-sided channel plate 21, second mono-sided channel plate 22, double-sided channel plates 30, membrane electrode assemblies 40, and gaskets 50 are fixed by the first oppressive collector board 11 and second oppressive collector board 12.

Moreover, the first oppressive collector board 11 comprises an anode inlet 11a, an anode outlet 11b, a cathode inlet 11c, and a cathode outlet 11d. Here, the methanol (CH₃OH) enters the fuel cell 1 via the anode inlet 11a and flows to the anode reaction sides 41 of the membrane electrode assemblies 40 through the first mono-sided channel plate 21 and double-sided channel plates 30 (as shown in FIG. 2). Here, the flow direction of the methanol is indicated by arrows A shown in FIG. 2. The methanol then leaves the fuel cell 1 via the anode outlet 11b. In another aspect, the oxygen enters the fuel cell 1 via the cathode inlet 11c and flows to the cathode reaction sides 42 of the membrane electrode assemblies 40 through the double-sided channel plates 30 and second mono-sided channel plate 22 (as shown in FIG. 2). Here, the flow direction of the oxygen is indicated by arrows B shown in FIG. 2. The oxygen then leaves the fuel cell 1 via the cathode outlet 11d.

Accordingly, by separation of the gaskets 50 attached between the first mono-sided channel plate 21 and the membrane electrode assembly 40, between the membrane electrode assembly 40 and the double-sided channel plate 30, and between the membrane electrode assembly 40 and the second mono-sided channel plate 22, the methanol supposed to flow to the anode reaction sides 41 of the membrane electrode assemblies 40 does not leak to the cathode reaction sides 42 of the membrane electrode assemblies 40 while the oxygen supposed to flow to the cathode reaction sides 42 of the membrane electrode assemblies 40 does not leak to the anode reaction sides 41 of the membrane electrode assemblies 40, thereby preventing mixing of the methanol and oxygen.

Nevertheless, when the fuel cell 1 is subjected to a non-uniform fastening force during assembly thereof or is subjected to external impact, deflection or deformation often occurs to the soft gaskets 50, as shown in FIG. 3. At this point, the deflected or deformed gaskets 50 can no longer provide proper separation between the first mono-sided channel plate 21 and the membrane electrode assembly 40, between the membrane electrode assembly 40 and the double-sided channel plate 30, and between the membrane electrode assembly 40 and the second mono-sided channel plate 22. Accordingly, when the methanol and oxygen enter the fuel cell 1 respectively via the anode inlet 11a and cathode inlet 11c, the methanol, flowing to the anode reaction sides 41, leaks to the cathode reaction sides 42 (as indicated by arrows A′) and the oxygen, flowing to the cathode reaction sides 42, leaks to the anode reaction sides 41 (as indicated by arrows B′), causing mixing of the methanol and oxygen. Thus, the operational efficiency and safety of the fuel cell 1 are adversely affected.

Hence, there is a need for a fuel cell with rigid hydrophilic gaskets that can provide airtight functions without application by using glue, preventing leakage and mixing of fuel and oxygen therein.

### BRIEF SUMMARY OF THE INVENTION

A detailed description is given in the following embodiments with reference to the accompanying drawings.

An exemplary embodiment of the invention provides a fuel cell comprising a first mono-sided channel plate, at least one double-sided channel plate, a second mono-sided channel plate, a plurality of membrane electrode assemblies, and a plurality of rigid hydrophilic gaskets. The double-sided channel plate comprises a first side channel and a second side channel opposite and separated from the first side channel. The membrane electrode assemblies are respectively disposed between the first mono-sided channel plate and the double-sided channel plate and between the double-sided channel plate and the second mono-sided channel plate. The membrane electrode assemblies comprise a plurality of anode reaction sides and a plurality of cathode reaction sides. The anode reaction sides respectively connect to a channel of the first mono-sided channel plate and the second side channel of the double-sided channel plate. The cathode reaction sides respectively connect to the first side channel of the double-sided channel plate and a channel of the second mono-sided channel plate. The rigid hydrophilic gaskets are respectively abutted between the first mono-sided channel plate and the anode reaction side of one of the membrane electrode assemblies, between the cathode reaction side of one of the membrane electrode assemblies and the first side channel of the double-sided channel plate, between the second side channel of the double-sided channel plate and the anode reaction side of one of the membrane electrode assemblies, and between the cathode reaction side of one of the membrane electrode assemblies and the second mono-sided channel plate.

The rigid hydrophilic gaskets are subjected to a plasma treatment to provide a plurality of polar groups. The rigid hydrophilic gaskets are attached to the first mono-sided channel plate, the anode reaction sides of the membrane electrode assemblies, the cathode reaction sides of the membrane electrode assemblies, the double-sided channel plate, and the second mono-sided channel plate by the polar groups and water.

The rigid hydrophilic gaskets are subjected to a corona treatment to provide a plurality of polar groups. The rigid hydrophilic gaskets are attached to the first mono-sided channel plate, the anode reaction sides of the membrane electrode assemblies, the cathode reaction sides of the membrane electrode assemblies, the double-sided channel plate, and the second mono-sided channel plate by the polar groups and water.

The hardness value of the rigid hydrophilic gaskets exceeds Rockwell hardness 50.

The fuel cell further comprises a first oppressive collector board and a second oppressive collector board. The first oppressive collector board opposes the second oppressive collector board and comprises an anode inlet and a cathode inlet. The anode inlet connects to the channel of the first mono-sided channel plate and the second side channel of the double-sided channel plate. The cathode inlet connects to the first side channel of the double-sided channel plate and the channel of the second mono-sided channel plate.

The first mono-sided channel plate, double-sided channel plate, and second mono-sided channel plate comprise graphite, metal, plastic, epoxy resin, macromolecular polymer, glass epoxy-group resin, or glass-reinforced macromolecular material.

### BRIEF DESCRIPTION OF THE DRAWINGS

The invention can be more fully understood by reading the subsequent detailed description and examples with references made to the accompanying drawings, wherein:

FIG. 1 is a schematic perspective view of a conventional fuel cell;

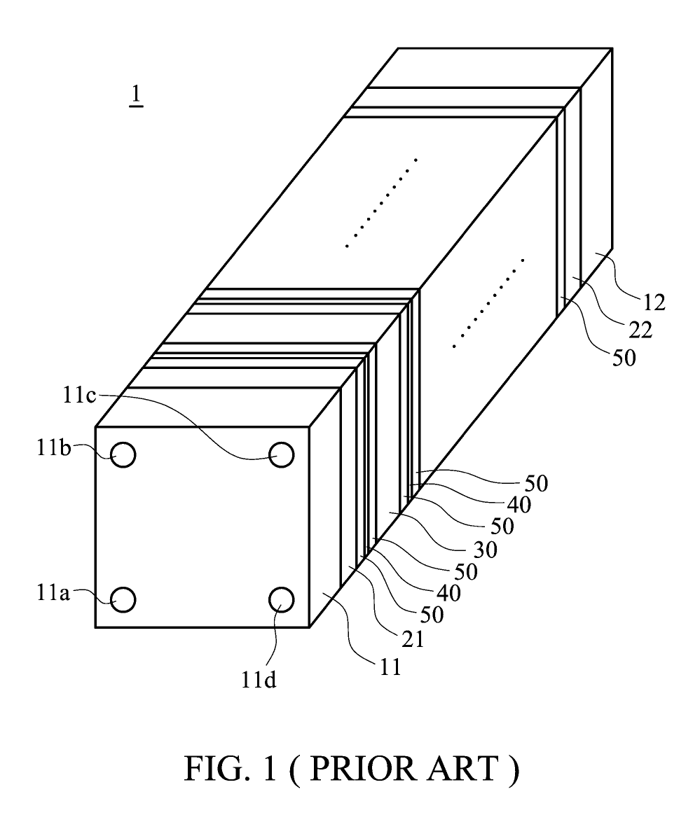

FIG. 2 is a schematic partial cross section of the conventional fuel cell in a normal operational status;

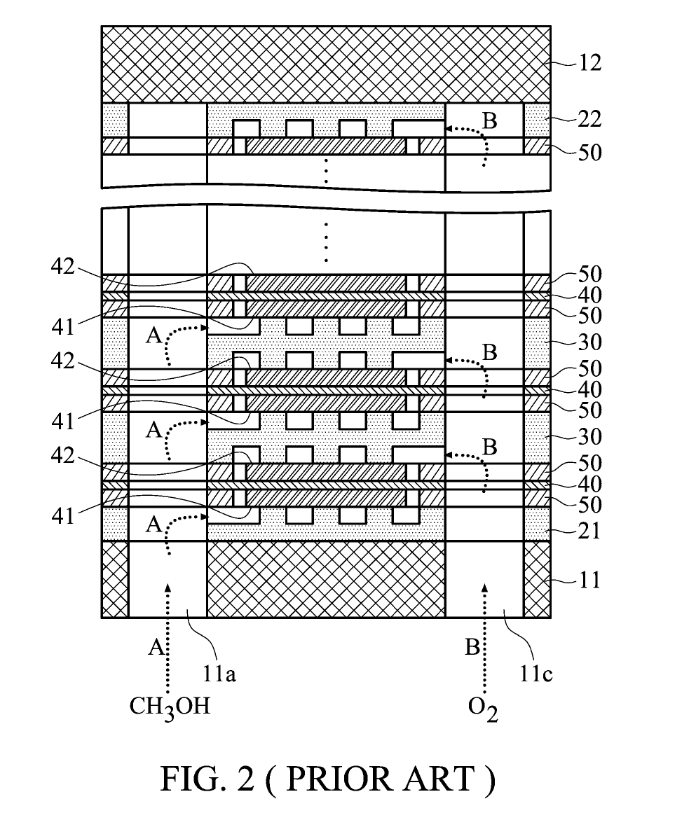

FIG. 3 is a schematic partial cross section of the conventional fuel cell in an abnormal operational status;

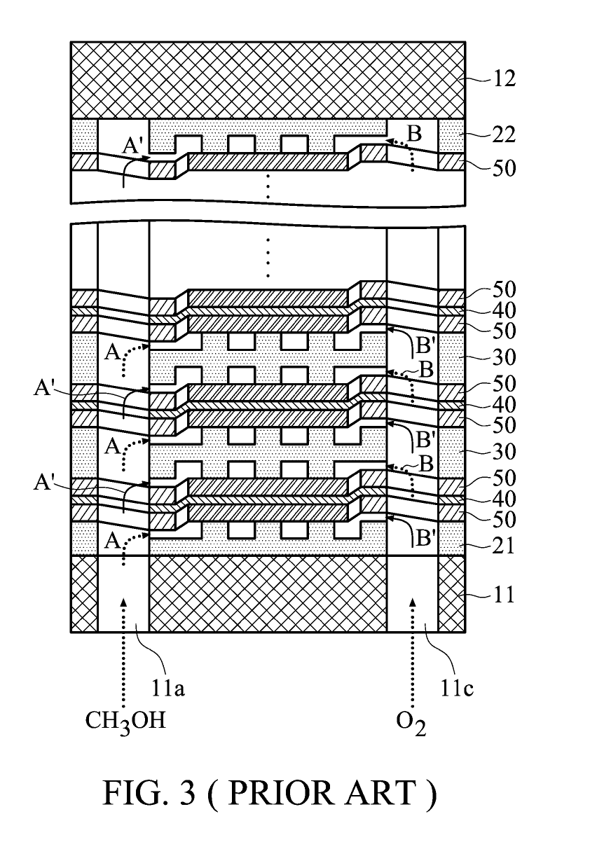

FIG. 4 is a schematic perspective view of a fuel cell of the invention;

FIG. 5 is a schematic partial cross section of the fuel cell of the invention; and

FIG. 6 is a schematic plane view of a partial structure of the fuel cell of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

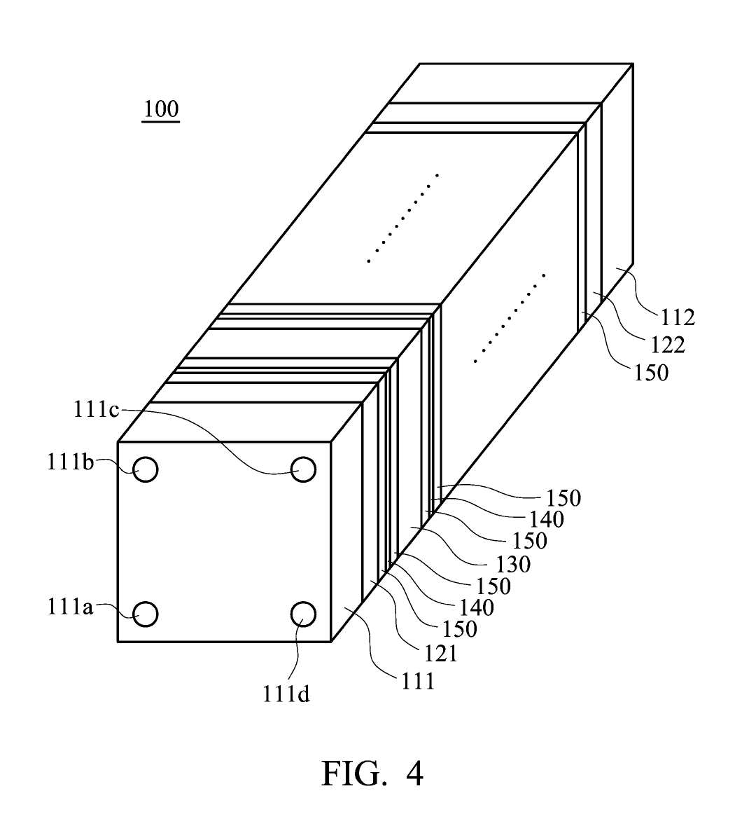

Referring to FIG. 4, a fuel cell 100 comprises a first oppressive collector board 111, a second oppressive collector board 112, a first mono-sided channel plate 121, a second mono-sided channel plate 122, a plurality of double-sided channel plates 130, a plurality of membrane electrode assemblies 140, and a plurality of rigid hydrophilic gaskets 150.

The first oppressive collector board 111 opposes the second oppressive collector board 112 and comprises an anode inlet 111a, an anode outlet 111b, a cathode inlet 111c, and a cathode outlet 111d.

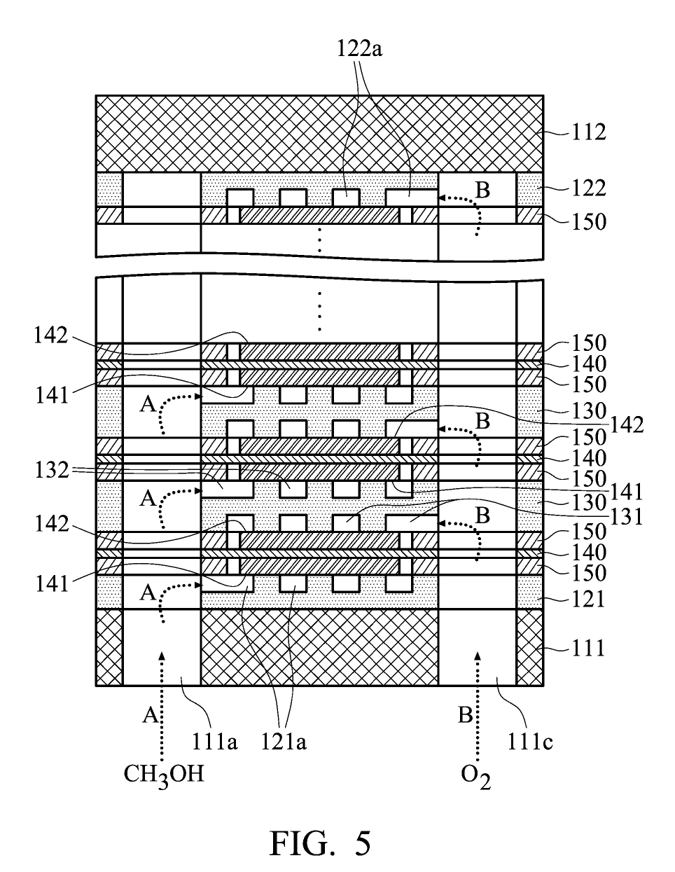

As shown in FIG. 4 and FIG. 5, the first mono-sided channel plate 121 and second mono-sided channel plate 122 abut the first oppressive collector board 111 and second oppressive collector board 112, respectively. Here, the first mono-sided channel plate 121 and second mono-sided channel plate 122 are respectively formed with a (curved) channel 121a and a (curved) channel 122a.

Each double-sided channel plate 130 comprises a first side (curved) channel 131 and a second side (curved) channel 132 opposite and separated from the first side channel 131, as shown in FIG. 5. Moreover, the first mono-sided channel plate 121, double-sided channel plates 130, and second mono-sided channel plate 122 may be composed of graphite, metal, plastic, epoxy resin, macromolecular polymer, glass epoxy-group resin, or glass-reinforced macromolecular material.

The membrane electrode assemblies 140 are respectively disposed between the first mono-sided channel plate 121 and the double-sided channel plate 130, between the double-sided channel plates 130, and between the double-sided channel plate 130 and the second mono-sided channel plate 122. Moreover, each membrane electrode assembly 140 comprises an anode reaction side 141 and a cathode reaction side 142. Here, as shown in FIG. 5, the anode reaction sides 141 respectively connect to the channel 121a of the first mono-sided channel plate 121 and the second side channels 132 of the double-sided channel plates 130, and the cathode reaction sides 142 respectively connect to the first side channels 131 of the double-sided channel plates 130 and the channel 122a of the second mono-sided channel plate 122.

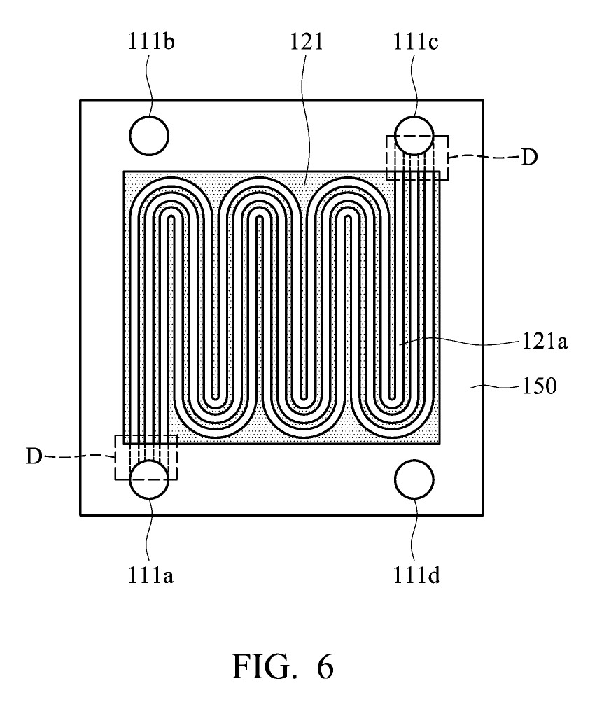

The rigid hydrophilic gaskets 150 are respectively abutted between the first mono-sided channel plate 121 and the anode reaction side 141 of one of the membrane electrode assemblies 140, between the cathode reaction side 142 of one of the membrane electrode assemblies 140 and the first side channel 131 of the double-sided channel plate 130, between the second side channel 132 of the double-sided channel plate 130 and the anode reaction side 141 of one of the membrane electrode assemblies 140, and between the cathode reaction side 142 of one of the membrane electrode assemblies 140 and the second mono-sided channel plate 122. Here, the rigid hydrophilic gaskets 150 may be subjected to a plasma or corona treatment to provide a plurality of polar groups, such as hydroxyl groups (OH). Specifically, the rigid hydrophilic gaskets 150 are attached to the first mono-sided channel plate 121 composed of graphite, the anode reaction sides 141 and cathode reaction sides 142 of the membrane electrode assemblies 140, the double-sided channel plate 130 composed of graphite, and the second mono-sided channel plate 122 composed of graphite by the polar groups and water. More specifically, the rigid hydrophilic gaskets 150 are not attached to the first mono-sided channel plate 121, the anode reaction sides 141 and cathode reaction sides 142 of the membrane electrode assemblies 140, the double-sided channel plate 130, and the second mono-sided channel plate 122 by glue. Moreover, in this embodiment, the hardness value of the rigid hydrophilic gaskets 150 exceeds Rockwell hardness 50. Thus, deflection or deformation can hardly occur on (bridges D, as shown in FIG. 6,) the rigid hydrophilic gaskets 150.

Additionally, as shown in FIG. 6, regarding abutment between the first mono-sided channel plate 121 and the rigid hydrophilic gasket 150, the rigid hydrophilic gasket 150 covers at least a part of the channel 121a connecting to the anode inlet 111a and cathode inlet 111c.

Accordingly, when the fuel cell 100 is assembled, the first mono-sided channel plate 121, second mono-sided channel plate 122, double-sided channel plates 130, membrane electrode assemblies 140, and rigid hydrophilic gaskets 150 are fixed by the first oppressive collector board 111 and second oppressive collector board 112. Here, as shown in FIG. 5, the anode inlet 111a of the first oppressive collector board 111 connects to the channel 121a of the first mono-sided channel plate 121 and the second side channels 132 of the double-sided channel plates 130, while the cathode inlet 111c of the first oppressive collector board 111 connects to the first side channels 131 of the double-sided channel plates 130 and the channel 122a of the second mono-sided channel plate 122.

When the fuel cell 100 is in operation, the fuel, such as methanol, enters the fuel cell 100 via the anode inlet 111a of the first oppressive collector board 111 and flows to the anode reaction sides 141 of the membrane electrode assemblies 140 through the channel 121a of the first mono-sided channel plate 121 and the second side channels 132 of the double-sided channel plates 130. Here, the flow direction of the methanol is indicated by arrows A shown in FIG. 5. The methanol then leaves the fuel cell 100 via the anode outlet 111b. In another aspect, the oxygen enters the fuel cell 100 via the cathode inlet 111c of the first oppressive collector board 111 and flows to the cathode reaction sides 142 of the membrane electrode assemblies 140 through the first side channels 131 of the double-sided channel plates 130 and the channel 122a of the second mono-sided channel plate 122. Here, the flow direction of the oxygen is indicated by arrows B shown in FIG. 5. The oxygen then leaves the fuel cell 100 via the cathode outlet 111d.

Accordingly, by separation of the rigid hydrophilic gaskets 150 abutted between the first mono-sided channel plate 121 and the membrane electrode assembly 140, between the membrane electrode assembly 140 and the double-sided channel plate 130, and between the membrane electrode assembly 140 and the second mono-sided channel plate 122, the methanol flowing to the anode reaction sides 141 of the membrane electrode assemblies 140 does not leak to the cathode reaction sides 142 of the membrane electrode assemblies 140 and the oxygen flowing to the cathode reaction sides 142 of the membrane electrode assemblies 140 does not leak to the anode reaction sides 141 of the membrane electrode assemblies 140.

Specifically, providing the high hardness, the rigid hydrophilic gaskets 150 do not deflect or deform even though the fuel cell 100 is subjected to a non-uniform fastening force during assembly thereof or is subjected to an external impact, securing the separation between the first mono-sided channel plate 121 and the membrane electrode assembly 140, between the membrane electrode assembly 140 and the double-sided channel plate 130, and between the membrane electrode assembly 140 and the second mono-sided channel plate 122, and further preventing leakage and mixing of the methanol and oxygen. Thus, the operational efficiency and safety of the fuel cell 100 is significantly enhanced. Moreover, as the rigid hydrophilic gaskets 150 are attached to the first mono-sided channel plate 121, the anode reaction sides 141 and cathode reaction sides 142 of the membrane electrode assemblies 140, the double-sided channel plates 130, and the second mono-sided channel plate 122 by the polar groups and water, an adhesion process employing glue can be omitted, effectively enhancing convenience for assembly of the fuel cell 100.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fuel cell, comprising:
a first mono-sided channel plate;
at least one double-sided channel plate comprising a first side channel and a second side channel opposite and separated from the first side channel;
a second mono-sided channel plate;
a plurality of membrane electrode assemblies respectively disposed between the first mono-sided channel plate and the double-sided channel plate and between the double-sided channel plate and the second mono-sided channel plate, wherein the membrane electrode assemblies comprise a plurality of anode reaction sides and a plurality of cathode reaction sides, the anode reaction sides respectively connect to a channel of the first mono-sided channel plate and the second side channel of the double-sided channel plate, and the cathode reaction sides respectively connect to the first side channel of the double-sided channel plate and a channel of the second mono-sided channel plate; and
a plurality of rigid hydrophilic gaskets respectively abutted between the first mono-sided channel plate and the anode reaction side of one of the membrane electrode assemblies, between the cathode reaction side of one of the membrane electrode assemblies and the first side channel of the double-sided channel plate, between the second side channel of the double-sided channel plate and the anode reaction side of one of the membrane electrode assemblies, and between the cathode reaction side of one of the membrane electrode assemblies and the second mono-sided channel plate.

2. The fuel cell as claimed in claim 1, wherein the rigid hydrophilic gaskets are subjected to a plasma treatment to provide a plurality of polar groups, and the rigid hydrophilic gaskets are attached to the first mono-sided channel plate, the anode reaction sides of the membrane electrode assemblies, the cathode reaction sides of the membrane electrode assemblies, the double-sided channel plate, and the second mono-sided channel plate by the polar groups and water.

3. The fuel cell as claimed in claim 1, wherein the rigid hydrophilic gaskets are subjected to a corona treatment to provide a plurality of polar groups, and the rigid hydrophilic gaskets are attached to the first mono-sided channel plate, the anode reaction sides of the membrane electrode assemblies, the cathode reaction sides of the membrane electrode assemblies, the double-sided channel plate, and the second mono-sided channel plate by the polar groups and water.

4. The fuel cell as claimed in claim 1, wherein the hardness value of the rigid hydrophilic gaskets exceeds Rockwell hardness 50.

5. The fuel cell as claimed in claim 1, further comprising a first oppressive collector board and a second oppressive collector board, wherein the first oppressive collector board opposes the second oppressive collector board and comprises an anode inlet and a cathode inlet, the anode inlet connects to the channel of the first mono-sided channel plate and the second side channel of the double-sided channel plate, and the cathode inlet connects to the first side channel of the double-sided channel plate and the channel of the second mono-sided channel plate.

6. The fuel cell as claimed in claim 1, wherein the first mono-sided channel plate, double-sided channel plate, and second mono-sided channel plate comprise graphite, metal, plastic, epoxy resin, macromolecular polymer, glass epoxy-group resin, or glass-reinforced macromolecular material.
